(19) United States
(12) Patent Application Publication
(10) Pub. No.: US 2013/0287640 A1
(43) Pub. Date: Oct. 31, 2013

(54) BASE METAL EXHAUST GAS CONTROL APPARATUS AND BASE METAL EXHAUST GAS CONTROL SYSTEM FOR INTERNAL COMBUSTION ENGINE

(71) Applicants: Masao Watanabe, Susono-shi (JP); Shigeharu Takagai, Miyoshi-shi (JP); Akira Morikawa, Nagoya-shi (JP); Takuto Hirose, Seto-shi (JP)

(72) Inventors: Masao Watanabe, Susono-shi (JP); Shigeharu Takagai, Miyoshi-shi (JP); Akira Morikawa, Nagoya-shi (JP); Takuto Hirose, Seto-shi (JP)

(21) Appl. No.: 13/979,395

(22) PCT Filed: Jan. 12, 2012
(86) PCT No.: PCT/IB12/00028

§ 371 Date: Jul. 12, 2013

(30) Foreign Application Priority Data
Jan. 14, 2011 (JP) 2011-006163
Aug. 25, 2011 (JP) 2011-183964

(51) Int. Cl. B01D 53/94

(52) U.S. Cl. CPC B01D 53/9477
USPC 422/170

(57) ABSTRACT

A base metal exhaust gas control apparatus for an internal combustion engine includes a basic structure having a first-stage base metal catalyst that oxidizes HC and CO, and a second-stage base metal catalyst that reduces NOx. The first-stage base metal catalyst oxidizes HC more efficiently than it oxidizes CO.

### BACKGROUND OF THE INVENTION

1. Field of the Invention

The present invention relates to a base metal exhaust gas control apparatus and a base metal exhaust gas control system for an internal combustion engine which uses only base metal as catalytic metal.

2. Description of Related Art

In the field of automobiles, etc., exhaust gas purifying catalysts employing noble metal such as Pt, Rh, or Pd as catalytic metal are used. Development is also underway for exhaust gas purifying catalysts that use base metal as catalytic metal instead of noble metal in order to reduce material cost.

Since base metal is far less active as catalytic metal than noble metal, among exhaust gas components HC, CO, and NOx, NOx is particularly difficult to reduce under normal stoich control.

For example, Japanese Patent Application Publication No. 2008-309013 (JP-A-2008-309013) discloses a catalytic device in which the catalyst is divided in two stages, air introduction means is further provided downstream of the upstream catalytic device, and air is introduced when the air/fuel ratio of exhaust gas from the internal combustion engine is controlled to be more fuel-rich than a stoichiometric air/fuel ratio to thereby effectively increase the amounts of HC and CO. However, if base metal is used as catalytic metal at this time, the catalyst device needs an even greater amount of CO to compensate for the far lower reduction performance of base metal than noble metal.

Specific examples of exhaust gas control apparatus using base metal as catalytic metal are given below.

Japanese Patent Application Publication No. 2010-013975 (JP-A-2010-013975) discloses an exhaust gas control apparatus for an internal combustion engine which has an NOx storage and reduction catalyst and an iron-based catalyst installed downstream of the NOx storage and reduction catalyst.

Japanese Patent Application Publication No. 2008-031970 (JP-A-2008-031970) discloses an exhaust gas treatment structure in which a first catalyst layer containing an iron element and having ammonia adsorption capacity, and a second catalyst layer including a noble metal and a ceric oxide are stacked in order, in an exhaust gas treatment system for a diesel engine.

Japanese Patent Application Publication No. 11-294150 (JP-A-11-294150) discloses a structure in which a three-way catalyst is installed on the upstream side and exhaust gas in a rich atmosphere is made to flow to thereby convert by reduction NOx and pass and CO at low oxidation conversion efficiencies, and in which a Cu-zirconia catalyst is placed on the downstream side and an oxidation catalyst is placed further downstream of the Cu-zirconia catalyst.

However, although the structures according to JP-A-2010-013975, JP-A-2008-031970, and JP-A-11-294150 all use base metal in a part of the exhaust gas control apparatus, the base metal plays only an auxiliary role, and noble metal is required as the principal component. As such, these are not structures that use only base metal as catalytic metal.

### SUMMARY OF THE INVENTION

The present invention provides a base metal exhaust gas control apparatus and a base metal exhaust gas control system for an internal combustion engine which uses only base metal as catalytic metal.

A base metal exhaust gas control apparatus for an internal combustion engine according to a first aspect of the invention includes a basic structure having a first-stage base metal catalyst that oxidizes HC and CO, and a second-stage base metal catalyst that reduces NOx. The first-stage base metal catalyst oxidizes HC more efficiently than it oxidizes CO.

The base metal exhaust gas control apparatus according to the above aspect oxidizes HC preferentially to CO when oxidizing HC and CO by the first-stage base metal catalyst, thereby effectively promoting reductive conversion of NOx by causing unoxidized CO to flow into the second-stage base metal catalyst.

In the base metal exhaust gas control apparatus for an internal combustion engine according to the above aspect, the first-stage base metal catalyst may include iron as a catalytic metal.

In the base metal exhaust gas control apparatus for an internal combustion engine according to the above aspect, the second-stage base metal catalyst may include copper as a catalytic metal.

A base metal exhaust gas control apparatus system for an internal combustion engine according to a second aspect of the invention includes the base metal exhaust gas control apparatus according to the first aspect of the invention. Exhaust gas with an air/fuel ratio that is slightly more fuel-rich than a stoichiometric air/fuel ratio is made to flow into the first-stage base metal catalyst.

A base metal exhaust gas control apparatus system for an internal combustion engine according to a third aspect of the invention includes the base metal exhaust gas control apparatus according to the first aspect of the invention. The base metal exhaust gas control apparatus further includes a third-stage base metal catalyst that oxidizes HC and CO and that is provided further downstream of the basic structure, and air introduction means provided between the basic structure and the third-stage base metal catalyst, and air is introduced from the air introduction means when an air/fuel ratio of exhaust gas from the internal combustion engine is controlled to be more fuel-rich than a stoichiometric air/fuel ratio.

In the base metal exhaust gas control system for an internal combustion engine according to the third aspect, exhaust gas with an air/fuel ratio that is slightly more fuel-rich than a stoichiometric air/fuel ratio may be made to flow into the first-stage base metal catalyst.

In the base metal exhaust gas control system for an internal combustion engine according to the third aspect, the third-stage base metal catalyst may include silver as a catalytic metal.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing an example of a base metal exhaust gas control apparatus according to the invention (Invention Example);

FIG. 2 is a schematic diagram showing the structure of an exhaust gas control apparatus according to Comparative Example 1;

FIG. 3 is a schematic diagram showing the structure of an exhaust gas control apparatus according to Comparative Example 2;

FIG. 4 is a schematic diagram showing the structure of an exhaust gas control apparatus according to Comparative Example 3;

FIG. 5 is a schematic diagram showing the structure of an exhaust gas control apparatus according to Invention Example; and

FIG. 6 is a schematic diagram showing the structure of an exhaust gas control apparatus according to Comparative Example 4.

### DETAILED DESCRIPTION OF EMBODIMENTS

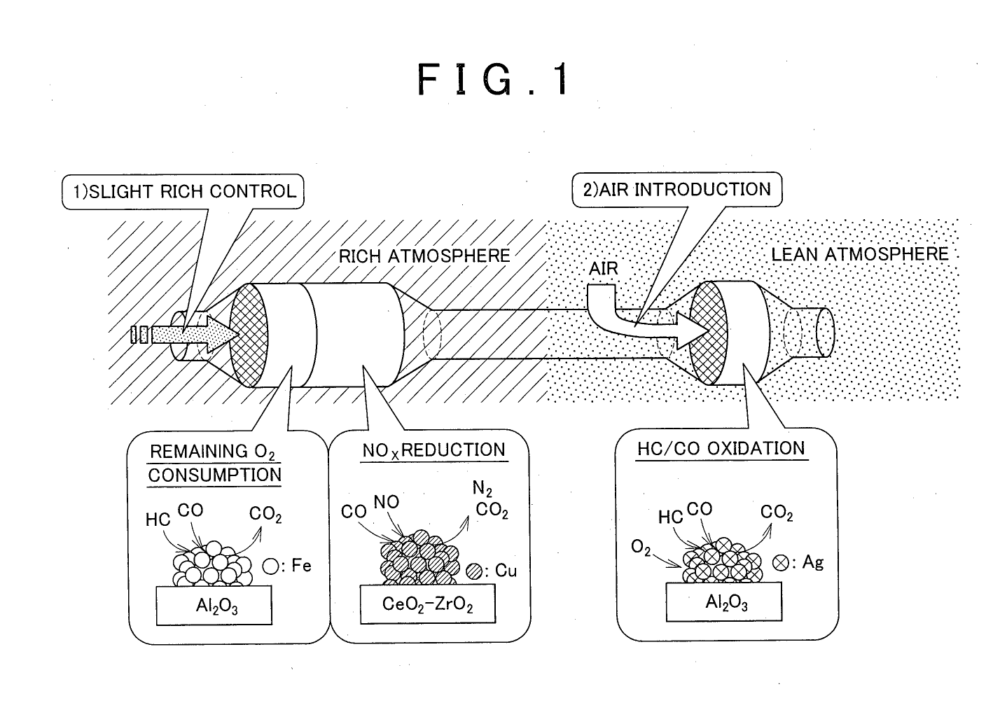

FIG. 1 shows an example of a base metal exhaust gas control apparatus according to the invention (Invention Example).

In the apparatus shown in FIG. 1, an Fe/Al₂O₃ catalyst (=catalytic metal/carrier, the same applies hereinafter) as a first-stage base metal catalyst, Cu/(CeO₂—ZrO₂) catalyst as a second-stage base metal catalyst, and an Ag/Al₂O₃ catalyst as a third-stage base metal catalyst located further downstream are arranged in order from the left to right in FIG. 1.

Exhaust gas from the engine is controlled to he slightly more fuel-rich (A/F=about 14) than stoich (A/F=14.6).

Under this condition, in the Fe/Al₂O₃ catalyst of the first stage, HC and CO are converted by oxidation with the remaining O₂ in the exhaust gas. The conversion efficiency at this time is higher for HC than CO. This is because HC partially oxidizes into CO. As for the CO remaining or produced at this point, in the Cu/(CeO₂—ZrO₂) catalyst of the second stage, NOx is converted by the CO—NO reaction mentioned below.

The CO—NO reaction is “CO+NO→CO₂+(½)N₂”, The HC and CO remaining at this point is converted by oxidation in the Ag/Al₂O₃ catalyst of the third stage which is additionally provided further downstream. To promote this oxidation, air is introduced as appropriate by the air introduction means provided between the second-stage catalyst and the third-stage catalyst.

### Example 1

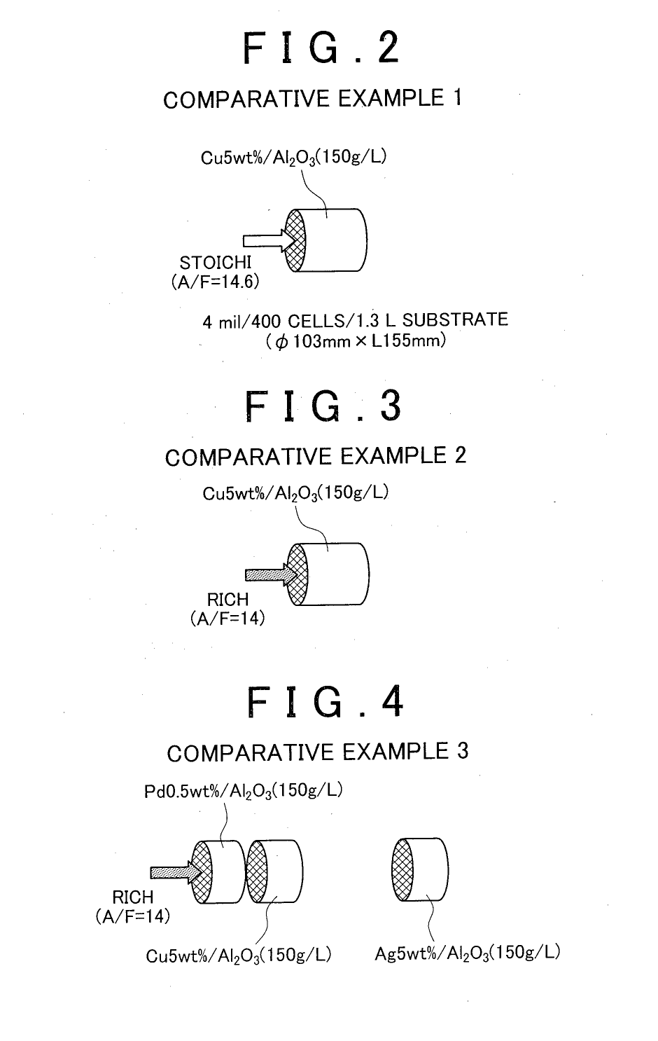

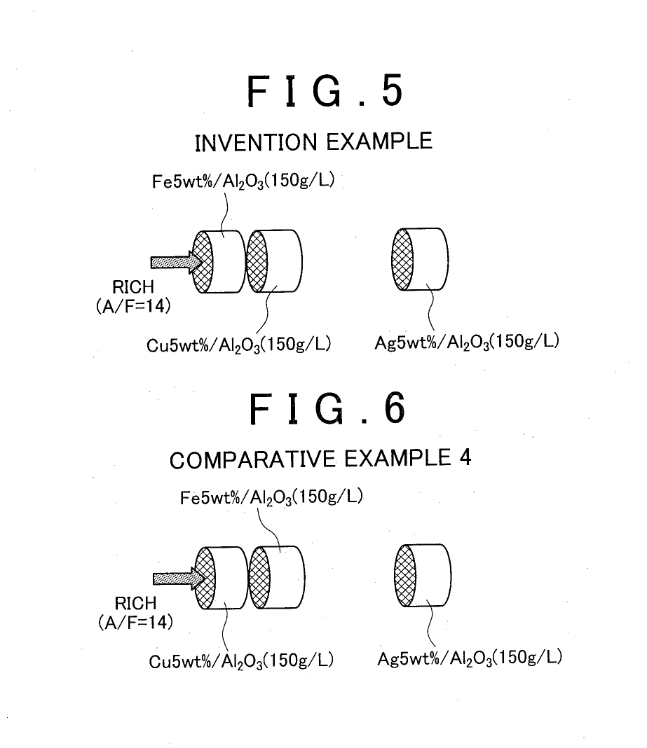

The conversion efficiencies for CO, HC, and NOx were measured for each of exhaust gas control apparatuses according to Comparative Examples 1 to 4 and Invention Example schematically shown in FIG. 2 to FIG. 6. Comparative Example 1 and Comparative Example 2 are the same in apparatus structure. The exhaust gas conditions were stoich (A/F=14.6) and rich (A/F=14) in Comparative Example 1 and Comparative Example 2, respectively. For Comparative Example 3, Comparative Example 4, and Invention Example, the exhaust gas conditions were rich (A/F=14) as in Comparative Example 2.

Detailed exhaust gas conditions are as follows. The engine used here is a 2400 cc engine.

### (Exhaust Gas Conditions)

### 1. Stoich

Composition: NOx 4000 ppm/O₂=0.6%/CO=0.45%/HC=1650 ppm C/CO₂=14%/

Temperature: 500° C.

### 2. Slightly Rich

Composition: NOx 3300 ppm/O₂=0.34%/CO=1.2%/HC=1850 ppm C/CO₂=14%/

Temperature: 500° C.

The measurement results of the conversion efficiencies are shown in Table 1.

TABLE 1
(Conversion Efficiency (%))

| | After first-stage | | | After second-stage | | | After third-stage | | |
|---|---|---|---|---|---|---|---|---|---|
| | catalyst | | | catalyst | | | catalyst | | |
| | CO | HC | NOₓ | CO | HC | NOₓ | CO | HC | NOₓ |
| Comparative | | | | 75.2 | 56.7 | 28.7 | | | |
| Example 1 | | | | | | | | | |
| Comparative | | | | 54.2 | 65.7 | 92.0 | | | |
| Example 2 | | | | | | | | | |
| Comparative | 90.3 | 79.4 | 39.3 | 100 | 91.1 | 56.7 | 100 | 95.3 | 59.6 |
| Example 3 | | | | | | | | | |
| Invention | 29.4 | 76.9 | 10.7 | 60.4 | 90.8 | 98.2 | 100 | 94.8 | 99.4 |
| Example | | | | | | | | | |
| Comparative | 54.2 | 65.7 | 92.0 | 58.0 | 89.2 | 93.5 | 100 | 94.7 | 93.5 |
| Example 4 | | | | | | | | | |

First, the results for Comparative Example 1 and Comparative Example 2 which are the same in apparatus structure and different only in exhaust gas composition are compared.

### (Apparatus Structure)

Apparatus structure in Comparative Example 1, 2: Cu 5wt %/Al₂O₃ (150 g/L)

Substrate: 4 mil/400 cells/1.3 L substrate

(φ103 mm×L155 mm)

### (The Substrate is Common to All of Comparative Examples 1 to 4 and Invention Example)

It is apparent from the results of Comparative Example 1 that the conversion efficiency of a Cu catalyst under stoichiometric conditions is generally low, and the NOx conversion efficiency, in particular, is as low as 28,7%. On the other hand, in Comparative Example 2, testing was done under slightly rich conditions. However, the CO conversion efficiency decreased under the slightly rich conditions (Comparative Example 2) in comparison to the stoichiometric conditions (Comparative Example 1). This is because the CO concentration of the engine's exhaust gas increases by as much as twice or more due to the rich control. It should be noted, however, that since CO—NO reaction is also promoted in the presence of high-concentration CO, the results also take the amount of conversion due to the CO—NO reaction into account.

Comparative Example 3 adopts the apparatus structure mentioned below in which, as shown in FIG. 4, with the same Cu/Al₂O₃ catalyst as that in Comparative Example 1, 2 placed in the second stage, a Pd/Al₂O₃ catalyst is placed in the preceding stage (first stage), and an Ag/Al₂O₃ catalyst is further placed in the last stage (third stage).

First stage: Pd 0.5 wt %/Al₂O₃ (150 g/L)

Second stage: Cu 5 wt %/Al₂O₃ (150 g/L)

Third stage: Ag 5 wt %/Al₂O₃ (150 g/L)

If, in order to enhance the reduction property of the Cu catalyst in the second stage, a powerful oxidation capability is added by a noble metal Pd in the preceding stage (first stage) so as to remove the remaining O₂, HC and CO (particularly CO) that serve as reducing agents in the second stage decrease excessively. That is, as shown in Table 1, CO and HC are oxidized and removed by the first-stage catalyst at conversion efficiencies of 90.3% and 79.4%, respectively. As a result, the NOx reducing action in the second stage decreases, and only a low conversion efficiency of 56.7% can be obtained. Ag in the third stage is a sweeper catalyst that oxidizes and removes HC and CO remaining after the second stage. Although the conversion efficiencies for HC and CO are 95.3% and 100%, respectively, only a low conversion efficiency of 59.6% can be obtained for NOx.

In contrast, the characteristic feature of invention Example resides in the following structure in which a Fe catalyst is placed in the stage (first stage) preceding the Cu catalyst in the second stage.

First stage: Fe 5 wt %/Al₂O₃ (150 g/L)

Second stage: Cu 5 wt %/Al₂O₃ (150 g/L)

Third stage: Ag 5 wt %/Al₂O₃ (150 g/L)

Since a Fe catalyst has high HC oxidation performance but is not easily fully oxidized, the Fe catalyst rather acts to produce CO, which promotes reductive conversion of NOx by CO—NO reaction in the Cu catalyst in the subsequent stage (second stage). That is, as shown in Table 1, according to Invention Example, in the first stage, while the conversion efficiency for HC is 76.9%, the conversion efficiency for CO is extremely low at 29.4%. In the second stage, a high conversion efficiency of 98.2% is achieved for NOx due to the presence of CO remaining after or produced in the first stage. The CO conversion efficiency is 60.4%, and the HC conversion efficiency is 90.8%. It is desirable that after the first stage, the concentration of CO serving as a reducing agent for reductive conversion of NOx to be converted be higher than the concentration of NOx. The CO and HC remaining after the second stage is converted by oxidation by the Ag catalyst in the third stage and, as a result, final conversion efficiencies of 100%, 94.5%, and 99,4% were achieved for CO, HC, and NOx, respectively.

Comparative Example 4 adopts the apparatus structure mentioned below in which, as shown in FIG. 6, the Fe catalyst in the first stage and the Cu catalyst in the second stage according to Invention Example are changed in their order.

First stage: Cu 5 wt %/Al₂O₃(150 g/L)

Second stage: Fe 5 wt %/Al₂O₃ (150 g/L)

Third stage: Ag 5 wt %/Al₂O₃ (150 g/L)

Comparing the NOx conversion efficiency after the second-stage catalyst between these examples, the NOx conversion efficiency of Cu alone (Comparative Example 2) is 92.0%, and while the NOx conversion efficiency is significantly improved to 98.2% in Invention Example in which the order of the first stage/second stage is Fe/Cu, the NOx conversion efficiency is 93.5% and hence no clear improvement is observed for Comparative Example 4 in which the order of the first stage/second stage is reversed to Cu/Fe. This low NOx conversion efficiency remains unchanged even after the third-stage catalyst, making it impossible to obtain an exhaust gas control apparatus with high performance.

This is because NOx is not sufficiently decomposed due to the high concentration of O₂ remaining in the Cu catalyst in the first stage, whereas the NOx conversion efficiency of the Fe catalyst in the second stage (the first stage in Invention Example) alone is low at 10.7%.

As described above, placing a Cu catalyst in the second stage and placing a Fe catalyst as the first stage in the preceding stage, which represents the characteristic feature of Invention Example, is an essential feature in ensuring high NOx conversion efficiency to achieve excellent catalytic performance.

### Embodiment 2

A basic reaction experiment was conducted to study combinations of active species and carrier suitable as the base metal catalyst of the first stage. The experimental conditions were as follows.

### (Experimental Conditions)

Carrying concentration of base metal catalyst: 5 wt % (common). Stoichiometric conditions of pellet=3 g, simulated gas=15 L/min., NO=1500 ppm/CO=0.65%/O₂=0.7%/C₃H₆=3000 ppm C/CO₂=10%/H₂O=5%/. Gas temperature=500° C.

The obtained results for Fe, Cu, and Ag are summarized in Table 2.

TABLE 2

Basic reaction@500° C.

| Active species | Carrier | CO | THC |
|---|---|---|---|
| Fe | SiO₂ | 12.8% | 40.9% |
| | TiO₂ | 14.2% | 44.9% |
| | Al₂O₃ | 29.4% | 76.9% |
| | ZrO₂ | 50.5% | 52.2% |
| | ZC | 57.7% | 41.0% |
| | CZ | 61.1% | 45.2% |
| | CeO₂ | 57.4% | 48.3% |
| Cu | TiO₂ | 82.5% | 71.8% |
| | Al₂O₃ | 98.6% | 93.8% |
| | ZrO₂ | 98.5% | 84.1% |
| | ZC | 100.0% | 78.6% |
| | CZ | 99.5% | 79.8% |
| | CeO₂ | 80.2% | 43.1% |
| Ag | TiO₂ | 77.7% | 66.2% |
| | Al₂O₃ | 97.7% | 79.8% |
| | ZrO₂ | 86.7% | 59.7% |
| | ZC | 80.7% | 51.3% |
| | CZ | 68.1% | 44.4% |
| | CeO₂ | 40.3% | 24.0% |

The condition for a combination that can be used as the base metal catalyst of the first stage is that its CO conversion performance is lower than the HC conversion performance, that is, the combination either produces CO or partially oxidizes HC.

From Table 2, the following four combinations satisfy this condition. (Combinations of active species/carrier suitable as a catalyst in the stage preceding the Cu catalyst)

Fe/SiO₂

Fe/TiO₂

Fe/Al₂O₃

Fe/ZrO₂

It should be noted, however, that the above combinations are merely the results obtained by limited experiments at the present time.

Any combination of catalytic metal/carrier may be applied to the base metal exhaust gas control apparatus according to the invention, as long as the combination includes a basic structure having a first-stage base metal catalyst that converts HC and CO by oxidation, and a second-stage base metal catalyst that converts NOx by reduction, and satisfies the condition that the first-stage base metal catalyst has a higher conversion efficiency for HC than CO.

According to the invention, there is provided a base metal exhaust gas control apparatus for an internal combustion engine which uses only base metal as catalytic metal.

1. A base metal exhaust gas control system for an internal combustion engine, comprising:
a base metal exhaust gas control apparatus that includes
a basic structure having a first-stage base metal catalyst, which oxidizes HC and CO, and which oxidizes HC more efficiently than it oxidizes CO, and a second-stage base metal catalyst that reduces NOx and
a third-stage base metal catalyst that oxidizes HC and CO and that is provided further downstream of the basic structure, and air introduction means provided between the basic structure and the third-stage base metal catalyst,
wherein the first-stage base metal catalyst includes iron as a catalytic metal, and the second-stage base metal catalyst includes copper as a catalytic metal,
air is introduced from the air introduction means when an air/fuel ratio of exhaust gas from the internal combustion engine is controlled to be more fuel-rich than a stoichiometric air/fuel ratio.

2. (canceled)

3. (canceled)

4. The base metal exhaust gas control system according to claim 1, wherein
exhaust gas with an air/fuel ratio that is slightly more fuel-rich than a stoichiometric air/fuel ratio is made to flow into the first-stage base metal catalyst.

5. (canceled)

6. (canceled)

7. The base metal exhaust gas control system according to claim 1, wherein the third-stage base metal catalyst includes silver as a catalytic metal.
